(19) United States
(12) Patent Application Publication
(10) Pub. No.: US 2004/0102873 A1
(43) Pub. Date: May 27, 2004

(54) System for maintaining power plant outage data

(76) Inventors: Randal Raymond Stark, Morgan Hill, CA (US); Ross John Marcoot, Gilroy, CA (US); John Carroll Whetsel, Gilroy, CA (US); James Davidson Adam, Livermore, CA (US); Ahdee Quan Chan, Morgan Hill, CA (US); Jimmy Hamilton Crow JR., Eagle, ID (US)

Correspondence Address: HARNESS, DICKEY & PIERCE, P.L.C., P.O. BOX 8910, RESTON, VA, 20195, US

(21) Appl. No.: 10/065,863

(22) Filed: Nov. 26, 2002

(51) Int. Cl. G05D 17/00

(52) U.S. Cl. 700/286

(57) ABSTRACT

A system for maintaining outage data provides for analysis of the data on a task by task basis. The data is electronically stored and used to generate reports, which may be provided automatically, and to determine best approaches to specific tasks. Monitoring of on-going tasks is also provided. The stored outage data is accessible both internal and external to the system.

### BACKGROUND OF THE INVENTION

The present invention relates generally to a system for maintaining electronically data relating to power plant outages.

Power plants (e.g., boiling water reactor plants) perform outages approximately once every two years. These outages are typically performed to provide scheduled maintenance activities, including, for example, replacing reactor fuel. During an outage, specific sets of tasks are performed, some of which are standard for maintaining a power plant, and others that may be plant specific. It is important to minimize the outage time for a particular plant in order to reduce the cost of the outage (i.e., less down time). For each outage, valuable data is processed, including summaries of the events for each day of the outage, lessons learned and/or outage task schedule information. This information is valuable in that it can be analyzed and used to enable the plants to optimize future outages (i.e., lower outage times).

Known methods for collecting and storing outage data are unreliable, and the information that is available, is often difficult to locate and/or access. In these known methods, daily outage reports, if provided at all, are typically generated by a project manager cutting and pasting the events of the day into the report from the previous day, and manually sending out the report. The outage metrics (e.g., measures) are tracked separately by a manual process and best in class data is often not captured at all.

### SUMMARY OF THE INVENTION

This present invention provides a system for consistently and reliably maintaining outage data. The outage data is automatically communicated (e.g., via email or an intranet) to provide updates to individuals involved in the particular plant outage being performed. Further, means to analyze the data (e.g., span, lessons learned, etc.) is also provided. An outage schedule optimizer is also included to provide best in class data.

In one embodiment of the present invention, a system for maintaining power plant outage data includes a user interface configured for receiving outage data, a database for storing the received outage data, and a controller for controlling the generation of output data based upon the stored outage data. The controller may be configured to automatically generate outage reports based upon search criteria from a user and/or to generate emails providing outage report summaries for automatic transmission to a predetermined list of users. The outage data stored within the database may be configured for access on a task by task basis.

In another embodiment of the present invention a method for maintaining power plant outage data includes receiving outage data input by a user, storing the received outage data for subsequent access, and generating output outage data based upon the stored outage data. The method may further include generating an outage report based upon a user defined search and providing outage data on a task by task basis. The method also may include outputting best in class data for a particular task based upon the stored outage data. Additionally, the method may include performing a search of the stored outage data based upon user search criteria.

In yet another embodiment of the present invention a method for maintaining power plant outage data for access by a user includes accessing a web based user interface configured to allow for searching of stored outage data, entering search criteria using the web based user interface for searching the stored outage data, and receiving search results based upon user input search criteria. The web based user interface may be configured to provide predetermined search fields. Further, the step of receiving may include displaying the search results.

### BRIEF DESCRIPTION OF THE DRAWINGS

The present invention will become more fully understood from the detailed description and the accompanying drawings, wherein:

FIG. 1 is a block diagram of a system constructed according to the principles of the present invention for maintaining outage data;

FIG. 2 is a screen shot of a main screen of the present invention;

FIGS. 3(a) and 3(b) are screen shots of an outage summary report screen of the present invention;

FIG. 4 is a screen shot of an outage tasks screen of the present invention; and

FIG. 5 is a screen shot of a delay detail screen of the present invention.

### DETAILED DESCRIPTION OF THE PREFERRED EMBODIMENTS

The following description of the preferred embodiments is merely exemplary in nature and is in no way intended to limit the invention, its application, or uses. Although the present invention is described in connection with maintaining specific outage data using particular system component parts, it is not so limited and different or additional outage data may be collected and stored using different or additional component parts.

The present invention provides an automated approach, which maybe configured as a web-based tool, to maintain (i.e., collect and store) outage related data. This data may include, but is not limited to, a summary of outage activities, an updated status of scheduled activities, an updated status on outage goals (FME goals, ALARA goals, Safety goals, etc.) and task specific outage metrics (e.g., measures). Further, this data may relate to a scheduled or forced outage (i.e., shutdown) of a power plant.

In general, outage data is collected and stored electronically for future use (e.g., automatic email distribution or analysis to improve future outage performance). In particular, this data may be used to provide the following information, reports and analysis, as described in more detail herein:

(1) Daily outage report summaries that will be available to individuals (e.g., plant employees) through an intranet;

(2) Daily outage report summaries that will be available to outside parties (e.g., customers) via the Internet, including for example, a Customer Web Center;

(3) Best in class data for each boiling water reactor (BWR) type outage task will be automatically provided to an Outage Schedule Optimizer;

(4) Outage task duration data will be automatically written to a file for span analysis; and

(5) Outage task performance data will be automatically written to a file for delay analysis. It should be noted that these uses are merely exemplary and the outage data may be used to provide other summaries or perform other types of analysis.

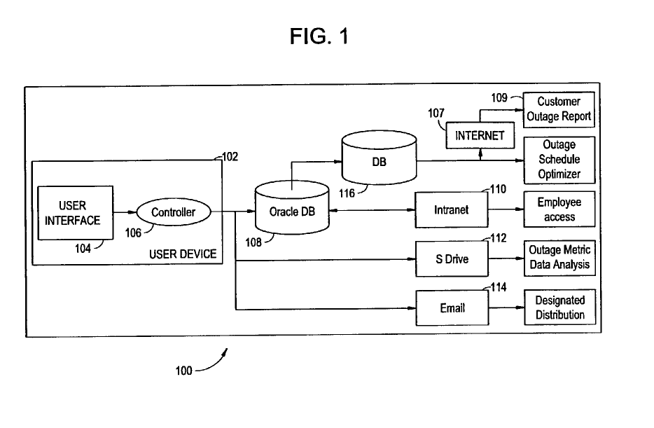

Specifically, and as shown in FIG. 1, a system 100 of the present invention for maintaining outage data includes a user device 102 (e.g., computer) having a user interface 104 for receiving outage data input by a user and a controller 106 configured to control the storage and transmission of the received outage data. The received outage data is stored within a first database 108 (e.g., Oracle database), which is accessible by individuals (e.g., employees) using an intranet (e.g., company intranet) 110. The received outage data also may be stored on a local drive 112 (e.g., network drive) or provided to an email system 114 for transmission to, for example, individuals on an email distribution list.

A second database 116 is also connected to the first database 108 to store the received outage data for external access, for example, using the Internet 107 to provide outage reports 109 to third parties, or for use in other systems or applications (e.g., schedule optimizer) as discussed in more detail herein. The first and second databases 108 and 116 may provide different levels of protection (i.e., data security) depending upon access requirements (i.e., internal versus external access).

Having described a system 100 of the present invention for maintaining outage data, one embodiment of a user interface 104 will now be described. Although described in connection with a display of a computer configured to provide the input functionality, the user interface 104 may be provided in connection with other types of devices, including, for example, using a Personal Digital Assistant (PDA).

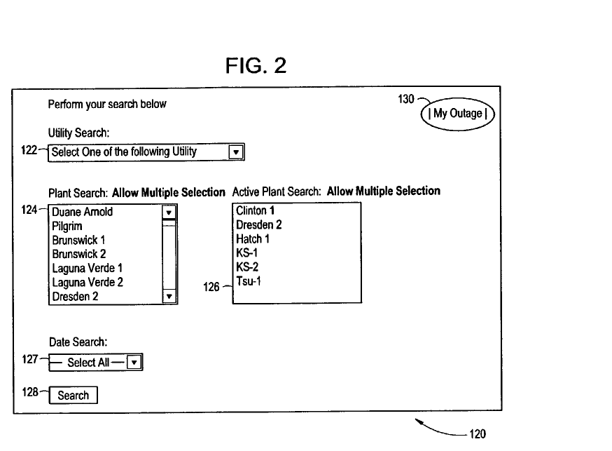

To begin, and as shown FIG. 2, a main screen 120 provides for searching for existing outage reports, which may then be viewed and/or updated, or for creating a new outage report. Specifically, search fields are provided including a Utility Search field 122, a Plant Search field 124, an Active Plant search field 126 and a Date Search field 127 for use in defining a search for specific received outage data (i.e., outage reports based upon previously entered information). The Utility Search field 120 allows for selection of a specific utility (e.g., utility company or customer) search criteria, the Plant Search field 122 allows for selection of a specific power plant search criteria, the Active Plant search field 124 allows for selection of a plant in which an outage is being performed and the Date Search field 127 allows for selection of a date search criteria. It should be noted that although the search fields are configured as pull-down menus, alternative configurations are possible, including, for example, a manual user input field (i.e., user types search criteria). Further, each of the search fields allow for selection of more than one search criteria and the Date Search field 126 allows for selection of all dates.

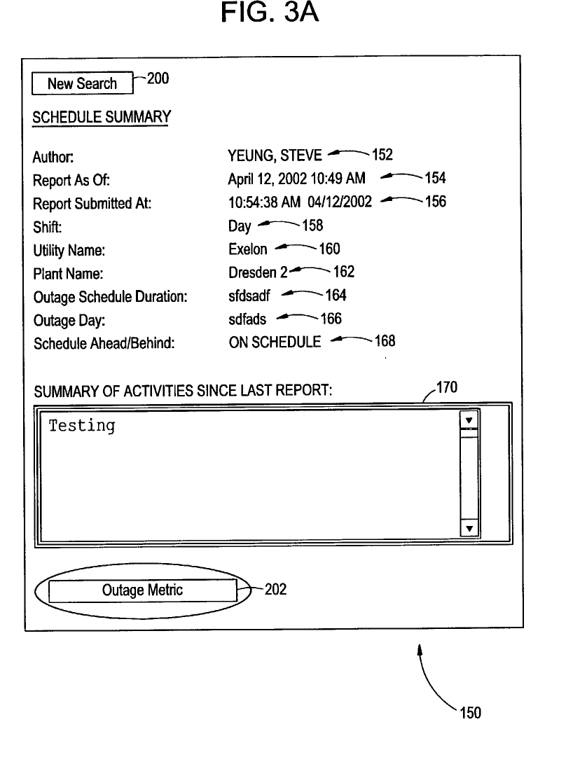

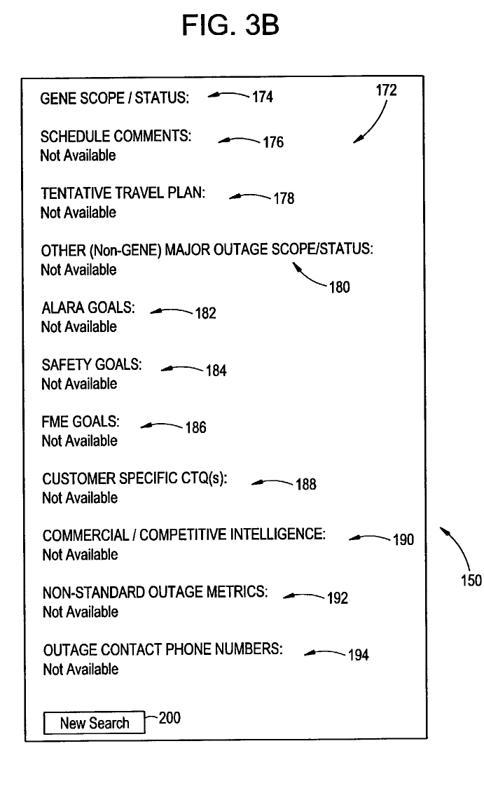

A search activation member 128 (e.g., Search virtual button) is provided to initiate a search based upon selected search criteria. Additionally, a new outage report activation member 130 (e.g., My Outage virtual button) is provided to link to a blank outage report screen that allows entry of specific outage data (e.g., current status of a particular task). Upon selecting (e.g., by clicking the Search virtual button with a mouse pointer) the search activation member 128, a search is performed based upon the search criteria and an outage summary report screen 150 is provided as shown in FIGS. 3(a) and 3(b). It should be noted that a separate outage summary may be provided for each search result (e.g., for each plant or different date). Further, the outage summary report screen 150 shown is for an on-going outage, but summary reports may be provided for past outages.

The outage summary report screen 150 provides a schedule summary for the outage data satisfying the search results. It should be noted that if the new outage report activation member 130 is selected, an outage summary report screen 150 with blank fields and sections is provided for entry of outage data.

In particular, the outage summary report screen 150 includes an Author field 152, a Report As Of field 154, a Report Submitted At field 156, a Shift field 158, a Utility Name field 160, a Plant Name field 162, an Outage Schedule Duration field 164, an Outage Day field 166 and a Schedule Ahead/Behind field 168. With respect to each of these fields the Author field 152 provides the name of the individual that provided the outage data and created (i.e., submitted) this report. The Report As Of field 154 provides the date and time that the report summary was generated. The Report Submitted At field 156 provides the date and time the report was originally submitted. The Shift field 158 identifies the shift to which the report relates (e.g., day or night). The Utility Name field 160 identifies the utility name to which the report relates and the Plant Name field 162 identifies the specific plant to which the report relates. The Outage Schedule Duration field 164 identifies the duration of the particular outage at the identified plant. The Outage Day field 166 identifies the day of the outage at the plant to which the report relates. The Schedule Ahead/Behind field 166 provides information regarding the current schedule of the outage (e.g., On Schedule).

A summary section 170 is provided and includes summary information regarding the outage, for example, the current general task being performed (e.g., testing). Additionally, a comment section 172 is provided and includes a Scope/Status section 174, a Schedule Comments section 176, a Tentative Travel Plan section 178, an Other Major Outage Scope/Status section 180, an ALARA Goals section 182, a Safety Goals section 184, an FME Goals section 186, a Customer Specific CTQ(s) section 188, a Commercial/Competitive Intelligence section 190, a Non-Standard Outage Metrics section 192 and an Outage Contact Phone Number section 194.

Specifically, the Scope/Status section 174 provides information regarding the scope of the outage being performed and additional status information. The Schedule Comments section 176 provides information regarding the schedule of the outage (e.g., if additional time is needed for a particular task). The Tentative Travel Plan section 178 provides information regarding travel by personnel involved in the outage. The Other Major Outage Scope/Status section 180 provides outage scope and status information regarding related outages being performed by third parties. The ALARA Goals section 182 provides information regarding radiation exposure. The Safety Goals section 184 provides information regarding general safety issues (e.g., an employee was injured). The FME Goals section 186 provides information regarding general problems at the outage (e.g., screwdriver has to be retrieved from machine). The Customer Specific CTQ(s) (Critical to Quality) section 188 provides information regarding key requirements (e.g., outage task must be completed in fifteen days) for a customer (e.g., utility company). The Commercial/Competitive Intelligence section 190 provides information regarding competitors” outages (e.g., task specific information regarding differences in approach). The Non-Standard Outage Metrics section 192 provides non-typical information regarding the outage (e.g., extra or different outage tasks to be performed in addition to the typical outage tasks). The Outage Contact Phone Number section 194 provides the contact number of the individual at the particular plant wherein the outage is being performed.

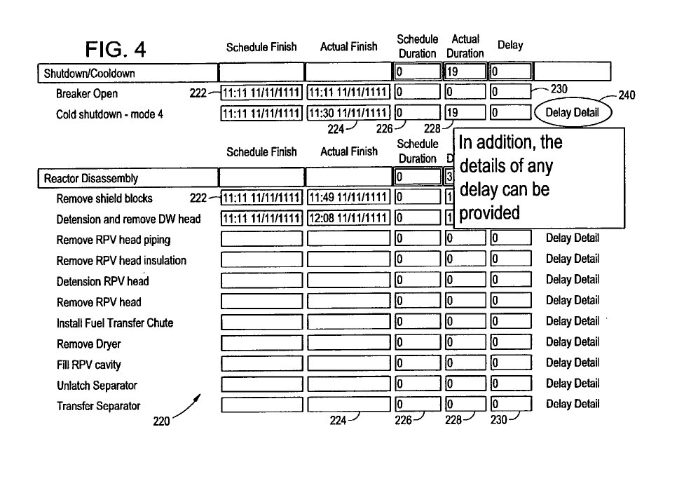

One or more new search activation members 200 (e.g., New Search virtual button) are provided to initiate a new search, which will link to the main screen 120 to enter new search criteria. An outage metrics activation member (e.g., Outage Metrics virtual button 202 in FIG. 3(a)) is provided to link to an outage tasks screen 220 as shown in FIG. 4. The outage tasks screen 220 includes specific information about the outage tasks (e.g., duration and delay). In particular, the outage tasks screen 220 provides the particular tasks to be or that have been performed relating to the outage. The tasks are categorized (e.g., Shutdown/cool down and Reactor Disassembly) and for each task the following fields are provided: a Schedule Finish field 222, an Actual Finish field 224, a Schedule Duration field 226, an Actual Duration field 228 and a Delay field 230. The Schedule Finish field 222 provides the time and date of the proposed completion for the task, the Actual Finish field 224 provides the actual time and date the task was completed, the Schedule Duration field 226 provides the number of hours scheduled to complete the task, the Actual Duration field 228 provides the number of hours to actually complete the task and the Delay field 230 provides the number of hours of delay, if any, for the task. It should be noted that the time durations may be provided in smaller time segments, including, for example, minutes.

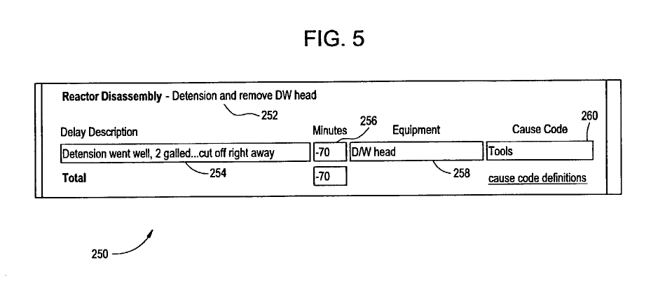

A delay detail activation member 240 (e.g., Delay Detail virtual button) is also provided to link to specific information regarding the delay for a particular task, which is displayed on a delay detail screen 250 as shown in FIG. 5. The delay detail screen 250 identifies the particular task selected at 252, and includes a Delay Description field 254, a Minute field 256, an Equipment field 258 and a Cause Code field 260. The Delay Description field 254 provides information relating to the delay (e.g., cause of the delay), the Minute field 256 provides the number of minutes of the delay, and may include a total if more than one delay occurred, the Equipment field 258 provides information regarding the specific equipment involved in the delay and the Cause Code field 260 provides a standard code to identify the cause of the delay.

In operation, a user (e.g., a Project Manager) will create an outage report using the user interface 104 configured having the various input and report screens as described herein. The outage data entered will then be stored within the first and second databases 108 and 116. It should be noted that different outage information may be provided to the first and second databases 108 and 116. Once submitted, an email will automatically be generated for each address (i.e., email address) on a designated distribution list. The email generally provides summary information regarding the outage data submitted. It should be noted that the system 100 may be configured to provide email updates at predetermined time periods (e.g., once in the morning and once in the afternoon).

Specific information (e.g., task duration and cause code) may be stored in different locations (e.g., local drive 112) for use in data analysis. The Intranet 110 may be configured to provide an outage report web site that can be accessed via the intranet to allow for access to the outage data. Third party access to the data may be provided via an Internet configured customer web center for viewing outage information. It should be noted that this outage information may be a limited or subsegment of the overall information submitted. Further, subsequent outage reports will generate the same files and at the end of the outage, the reports will be available for a predetermined period of time, after which they will be archived.

Additionally, the outage data is provided to an Outage Schedule Optimizer to update the best in class data. With respect to the Outage Schedule Optimizer, the data is stored and similar or same tasks are compared for outages at different and/or the same location (i.e., power plant facility) at different times. A gap analysis may then be performed for each task to determine the best in class (i.e., lowest time to completion). A report may then be generated showing details regarding the best in class for a particular task. This may include the specific operations or procedures that were performed for the task. The Outage Schedule Optimizer essentially calculates the overall scheduled duration of the tasks for a particular outage and calculates the overall scheduled duration of best in class data for the same tasks, which may be used, for example, to perform comparisons of scheduled durations for particular tasks to the best in class duration data for those tasks. For example, a comparison of proposed durations (e.g., customer expect durations) to best in class duration data may be performed. Also, and for example, a comparison of actual duration data from a particular outage to best in class duration data may be performed.

Further, the outage data collected may be analyzed to determine a span, which is the difference in completion time for same or similar tasks performed at different times and/or locations (i.e., variances). Using the task specific data, a span calculation can be performed for each task to try and achieve a zero span result. For example, if a scheduled task is set for 18 hours and the task is completed in 22 hours, the span is 4 hours. Thus, using span analysis and the Outage Schedule Optimizer, outage task completion times may be decreased.

The description of the invention is merely exemplary in nature and, thus, variations that do not depart from the gist of the invention are intended to be within the scope of the invention. Such variations are not to be regarded as a departure from the spirit and scope of the invention.

1. A system for maintaining power plant outage data comprising:
a user interface configured for receiving outage data;
a database for storing the received outage data; and
a controller for controlling the generation of output data based upon the stored outage data.

2. The system according to claim 1 wherein the controller is configured to automatically generate outage reports based upon search criteria from a user.

3. The system according to claim 1 wherein the controller is configured to generate emails providing outage report summaries for automatic transmission to a predetermined list of users.

4. The system according to claim 1 wherein the database is configured for access via an intranet and further comprising a second database for storing the received outage data and configured for access via an internet.

5. The system according to claim 1 wherein the outage data stored within the database is configured for access on a task by task basis.

6. The system according to claim 1 wherein the user interface is configured for receiving search criteria from a user to perform a search for outage data within the database.

7. The system according to claim 1 further comprising a local storage device for storing at least some of the outage data.

8. The system according to claim 1 further comprising an outage schedule optimizer for use in determining best in class outage data.

9. The system according to claim 1 wherein the user interface is configured to include a plurality of input fields to receive the outage data.

10. The system according to claim 9 wherein the user interface is configured for display to provide user input screens for inputting the outage data.

11. A method for maintaining power plant outage data comprising:
receiving outage data input by a user;
storing the received outage data for subsequent access; and
generating output outage data based upon the stored outage data.

12. The method according to claim 11 wherein the step of generating output outage data comprises automatically generating an email summary of an outage report.

13. The method according to claim 11 wherein the step of generating output outage data comprises generating an outage report based upon a user defined search and providing outage data on a task by task basis.

14. The method according to claim 11 further comprising outputting best in class data for a particular task based upon the stored outage data.

15. The method according to claim 11 further comprising automatically storing outage task duration data for separate access by a user.

16. The method according to claim 11 further comprising performing a search of the stored outage data based upon user search criteria.

17. The method according to claim 11 further comprising limiting access to at least some of the stored outage data.

18. A method for maintaining power plant outage data for access by a user, the method comprising:
accessing a web based user interface configured to allow for searching of stored outage data;
entering search criteria using the web based user interface for searching the stored outage data; and
receiving search results based upon user input search criteria.

19. The method according to claim 18 wherein the user interface is configured to provide predetermined search fields.

20. The method according to claim 18 wherein the step of receiving comprises displaying the search results.

21. The method according to claim 18 further comprising providing the search results on a task by task basis.

22. The method according to claim 18 wherein the step of accessing comprises using an intranet to access the stored outage data.

23. The method according to claim 18 wherein the step of accessing comprises using an internet to access the stored outage data.
